(19) United States
(12) Patent Application Publication
(10) Pub. No.: US 2019/0011178 A1
(43) Pub. Date: Jan. 10, 2019

(54) DOMESTIC APPLIANCE DEVICE

(71) Applicant: BSH HAUSGERAETE GMBH, MUENCHEN (DE)

(72) Inventors: ANDREAS KESSLER, MUENCHEN (DE); PHILIPP KLEINLEIN, MUENCHEN (DE); ROBERT SACHON, MUENCHEN (DE); RALPH STAUD, MUENCHEN (DE); THOMAS TISCHER, HAAR (DE)

(73) Assignee: BSH HAUSGERAETE GMBH, MUENCHEN (DE)

(21) Appl. No.: 16/067,148

(22) PCT Filed: Jan. 23, 2017
(86) PCT No.: PCT/EP2017/051296

§ 371 Date: Jun. 29, 2018

(30) Foreign Application Priority Data
Feb. 12, 2016 (DE) 10 2016 202 189.3

(51) Int. Cl. F25D 25/02; B23P 19/04

(52) U.S. Cl. CPC F25D 25/02; F25D 2323/06; F25D 2325/022; B23P 19/04

(57) ABSTRACT

A domestic appliance device, in particular a domestic refrigerator device, includes at least one storage unit and at least one holding unit that is provided to hold the storage unit in at least one operating state in which the storage unit is located completely in an appliance body. The aim of the invention is to advantageously hold storage units of a domestic appliance. This is achieved in that the holding unit is provided at most in an edge region of the storage unit in the operating state in order to hold the storage unit. The extension of the edge region in at least one direction perpendicular to a direction of a torque that occurs during holding corresponds maximally or at most to 30% of the extension of the storage unit along that direction. A method for holding a storage unit is also provided.

The invention relates to a domestic appliance device according to the preamble of claim 1 and a method with a domestic appliance device according to the preamble of claim 15.

A domestic appliance device with holding profiles for shelves is already known from the prior art. Such holding profiles are deep drawn into a carcass of an appliance inner housing during production, two holding profiles arranged on opposing side walls of the appliance inner housing being provided for each shelf, the shelf being able to be inserted into said holding profiles. In an inserted state the shelf is then held by both the holding profiles assigned to it in a horizontal position at a defined height in an inner chamber of the appliance inner housing.

It is the object of the invention in particular to provide a generic device with improved properties in respect of support for storage units of a domestic appliance. The object is achieved by the characterizing features of claims 1 and 15, while advantageous configurations and developments of the invention will emerge from the sub claims.

The invention is based on a domestic appliance device, in particular a domestic refrigeration appliance device, with at least one storage unit and with at least one holding unit, which is provided to hold the storage unit in at least one operating state, in which the storage unit is present in its entirety in an appliance carcass.

It is proposed that in the operating state the holding unit is provided to hold the storage unit as a maximum in an edge region of the storage unit, the extension of said edge region corresponding, in at least one direction perpendicular to a direction of a torque that results during holding, to maximum 30%, in particular maximum 20%, preferably maximum 15%, advantageously to maximum 10% and particularly advantageously to maximum 6% of the extension of the storage unit along said direction.

“Provided” means in particular specifically programmed, designed and/or equipped. That an object is provided for a specific function means in particular that said object performs and/or executes said specific function in at least one application and/or operating state. An “edge region” of an object refers in particular to a region that, from a plane adjoining at least one end of the object, which as a maximum touches said object, to a second plane parallel to the first plane and intersecting the object, follows the shape of the object and is delimited on one side by the second plane. An “extension” of an element refers here in particular to a maximum distance between two points of a perpendicular projection of the element onto a plane.

A “torque that results during holding” refers in particular to an effective torque that results in particular due to the storage unit being held along an axis away from the center of gravity of the storage unit. In particular the effective torque corresponds to the vectorial cross product of the sum of the force of gravity of the storage unit and any objects standing or lying on the storage unit and a direction vector from the axis to a shared center of gravity of the storage unit and any objects. The effective torque preferably runs at least substantially parallel to a side of the storage unit. In particular the at least one direction perpendicular to the direction of the torque that results during holding runs parallel to a main extension plane of the storage unit. A “main extension plane” of an object refers in particular to a plane running parallel to a greatest side surface of a smallest notional square that still completely encloses the object and in particular through the center point of the square. “At least substantially” in this context means in particular that a deviation from a predefined value is in particular less than 25%, preferably less than 10% and particularly preferably less than 5% of the predefined value. “At least substantially parallel” here refers in particular to an alignment of a direction relative to a reference direction, in particular in a plane, the direction deviating from the reference direction in particular by less than 8°, advantageously less than 5° and particularly advantageously less than 2°.

A “domestic appliance device” in this context refers in particular to an, in particular functioning, part, in particular a structural and/or functional components of a domestic appliance, in particular of a domestic refrigeration appliance. The domestic appliance device can in particular also cover the entire domestic appliance, in particular the entire domestic refrigeration appliance. A domestic appliance configured as a domestic refrigeration appliance is particularly preferably configured as a refrigeration and/or freezer appliance, in particular a refrigerator, chiller cabinet, freezer cabinet, chest freezer, combined refrigerator/freezer and/or wine storage cabinet. A “storage unit” refers in particular to a unit which is provided to hold objects, in particular food, standing or lying thereon. In particular the storage unit can be configured at least substantially in the manner of a plate and/or have at least one element configured at least substantially in the manner of a plate, and can be provided in particular to hold objects, in particular food, standing or lying thereon in a region configured in the manner of a plate. An object “in the manner of a plate” refers here in particular to an object that has a significantly greater extension along a first spatial direction and along a second spatial direction than along a third spatial direction, preferably an extension that is greater by at least factor 5, advantageously by at least factor 10 and particularly advantageously by at least factor 20, pairs of the three spatial directions being perpendicular to one another.

An “appliance carcass” refers in particular to a unit that in at least one assembled state forms a part, in particular a greatest part, of an outer delimitation, in particular of a housing, advantageously of a domestic appliance, preferably of a domestic refrigeration appliance, and that in the assembled state defines a part, in particular a greatest part, of an outer delimitation at least of an inner chamber, preferably of a refrigeration chamber and particularly preferably of a chiller chamber and/or a freezer chamber. The appliance carcass advantageously has an opening on one side. The appliance carcass particularly advantageously encloses the inner chamber at an upper face, a lower face, two opposing side faces and at a rear face, a front face in particular remaining open. In particular a door arranged on the front face is separate from the appliance carcass.

The inventive configuration in particular allows advantageous support for storage units of a domestic appliance device, in particular of a domestic refrigeration appliance. In particular storage units can be arranged in a domestic appliance carcass with predominantly flat inner walls, making the walls in particular easy to clean. The storage units can also advantageously be cleaned easily, in particular at edges away from the edge region. Differently configured storage units, in particular shelves or bottle storage units, can advantageously be held just at one side in a domestic appliance. This gives the inner chamber in particular a homogeneous appearance. Storage units made of different materials can also advantageously be held in a similar manner. An inventive configuration in particular advantageously gives a visual impression of space. A modern attractive design advantageously results, in particular a frameless design.

The domestic appliance device advantageously comprises the appliance carcass, in which the holding unit is arranged. In particular the holding unit is connected to the appliance carcass, in particular connected as a single piece, advantageously to a wall of the appliance carcass. The holding unit is advantageously connected to at least one holding rail, which is provided at least partially to absorb a force and/or torque resulting during holding. The holding unit is particularly advantageously fastened to the at least one holding rail in such a manner that its height can be adjusted. In particular the at least one holding rail is fastened to the appliance carcass. The holding rail is advantageously fastened to a wall of the appliance carcass. It is however also conceivable for the holding unit to be connected to a frame unit introduced into the appliance carcass and present in its entirety in the inner chamber in at least one operating state. This advantageously allows a plurality of arrangements of the holding unit in the appliance carcass. It also means that the holding unit arrangement can be protected.

It is further proposed that the holding unit is arranged, in particular fastened, in a rear region of the appliance carcass. A “rear region” here refers in particular to a region in front of a face of the inner chamber facing away from the door, in particular a region in front of a rear wall of the appliance carcass. In particular the regions extends to a rear half of the inner chamber, advantageously a rear third of the inner chamber, particularly advantageously a rear quarter of the inner chamber. That “the holding unit is arranged in a rear region of the appliance carcass” means in particular that in an assembled state the holding unit is present in its entirety in the rear region. The holding unit is advantageously arranged on, in particular fastened to, the rear wall of the appliance carcass. It is however also possible for the holding unit to be arranged on, in particular fastened to, at least one side wall of the appliance carcass. This advantageously allows the holding unit to be suspended in a region away from a user of the domestic appliance. In particular the holding unit is not immediately visible to the user of the domestic appliance. In particular it allows an impression of a floating storage unit to be achieved. It also improves access.

In one preferred configuration of the invention it is proposed that the holding unit has at least one holding profile with at least one holding recess, into which at least part of the edge region can be inserted. The holding profile here can in particular have an at least substantially constant cross section. In particular the holding profile can be an element that can be produced by extrusion. The holding profile is advantageously a continuously cast profile. It is however also possible for the holding profile to be an element that can be produced from metal sheet. In particular the holding profile can be shaped in such a manner that it has a holding recess. A main extension direction of the holding recess advantageously runs at least substantially parallel to a main extension direction of the holding profile. A “main extension direction” of an object here refers in particular to a direction running parallel to a longest edge of a smallest notional square that still completely encloses the object. That at least part of the edge region “can be inserted” into the holding recess means in particular that in an inserted state at least part of the edge region is connected to at least part of the holding profile with a form fit. At least part of the edge region can advantageously be inserted into the holding recess without tools. At least part of the edge region can particularly advantageously be inserted into the holding recess by a linear movement and/or a tilting movement of the storage unit relative to the holding unit. This advantageously allows the storage unit to be held securely. In particular the storage unit can advantageously be fitted and/or removed easily.

In one particularly preferred configuration of the invention it is proposed that the holding profile has at least one upper holding element and at least one lower holding element, which at least partially delimit the holding recess, the lower holding element having a greater extension along the direction than the upper holding element. A “holding element” here refers in particular to an element provided for at least partially form-fit connection to the edge region. The holding element is advantageously provided at absorb at least some of a holding force that results during holding and/or at least some of a torque that results during holding. The upper and lower holding elements are in particular each embodied at least substantially in the manner of a wall, against which part of the edge region rests during holding. The holding recess advantageously forms a groove. In particular the upper holding element and the lower holding element are configured at least partially as opposing walls of the groove. This advantageously allows the holding profile to have a simple structure. In particular advantageous properties can be achieved in respect of absorption of the holding forces by the holding unit.

It is also proposed that a main extension direction of the holding recess runs at least substantially in a horizontal direction. “At least substantially in a horizontal direction” here refers in particular to an alignment relative to a surface normal of a substrate, in particular a ground surface, the direction deviating from a direction perpendicular to the surface normal of the substrate in particular by less than 8°, advantageously less than 5° and particularly advantageously less than 2°. This advantageously allows a statically favorable alignment of the holding recess. In particular it allows the storage unit to be aligned parallel to the substrate. This advantageously prevents objects sliding on the storage unit.

It is further proposed that a main extension direction of the holding recess runs at least substantially parallel to a main extension direction of the holding unit. This advantageously allows any resulting forces to be distributed evenly on the holding unit. In particular the holding unit is simple to produce and ensures secure holding.

The holding profile advantageously extends over at least a majority of an extension of the holding unit in a main extension direction of the holding unit. “At least a majority” here means in particular at least 55%, advantageously at least 65%, preferably at least 75%, particularly preferably at least 85% and particularly advantageously at least 95%. This advantageously gives the holding unit a homogeneous appearance. In particular it allows the holding unit to be produced using favorable procedures, for example by means of extrusion and/or continuous casting.

In a further configuration of the invention it is proposed that the storage unit has a shelf and is preferably configured as such. A “shelf” here refers to a plate-like element that is provided for the storage of objects standing or lying thereon, in particular food. This advantageously allows objects, in particular food, to stand securely on the storage unit. In particular it means that the storage unit is easy to clean.

In one preferred configuration of the invention it is proposed that the shelf is configured to be at least partially and preferably completely transparent and frameless and/or at least partially and preferably completely translucent and frameless. At least partially “transparent” here means in particular at least partially transparent for visible light, in particular a transparency of at least 5%, preferably at least 10%, particularly preferably at least 20%, advantageously at least 50% and particularly advantageously at least 80%, transmitted light being at least substantially parallel to incident light. At least partially “translucent” here means in particular at least partially translucent for visible light, in particular a permeability of at least 5%, preferably at least 10%, particularly preferably at least 20%, advantageously at least 50% and particularly advantageously at least 80% for an incident light, exiting light being scattered at least substantially at an angle different from 0 to the incident light. “Frameless” here means in particular that the shelf is made of the same material to its edges as at its edges. In particular the shelf has the same cross section to its edges as at its edges. In particular the shelf is made of glass, advantageously of safety glass. In particular the shelf can be made of at least partially opaque glass, in particular frosted glass. The shelf is advantageously configured as a frameless glass plate. It is however also possible for the shelf to be made of plastic. This advantageously allows objects below the shelf to be visible through it. In particular this improves user-friendliness.

In one particularly preferred configuration of the invention it is proposed that the holding unit has at least one light source, which is provided to couple light into the storage unit at at least one point on the edge region. It is advantageously a light source for visible light. It is however possible for it to be a light source for ultraviolet and/or infrared light. In particular the light source has at least one light bulb, preferably a row of light bulbs, and/or preferably at least one LED, preferably a row of LEDs, and/or a fluorescent tube. In particular the light source extends along the main extension direction of the holding unit. The light source is advantageously arranged in the holding recess. The extended light source particularly advantageously extends over at least a majority of the length of the holding recess in a direction parallel to a main extension direction of the holding recess. In particular the holding unit has at least one sensor unit, which is provided to recognize the storage unit. It is advantageously possible to distinguish between a state in which a storage unit is inserted into the holding unit and a state in which no storage unit is inserted into the holding unit. This advantageously allows the storage unit to be lit. Glass plates can also advantageously be lit in a simple manner. In particular the light source itself is not directly visible to the user of the domestic appliance, giving the impression of an automatically illuminating storage unit. Black light effects can advantageously be generated in particular with a light source for ultraviolet light.

It is also proposed that the storage unit has at least one diffusion center, which is provided to couple out at least some of the light coupled into the storage unit. A “diffusion center” refers in particular to an object, at which incident parallel light, in particular visible light, ultraviolet light or light from the near infrared, is diffused in different directions in such a manner that the diffused light is non-parallel light, and at which incident non-parallel light is diffused in such a manner that the diffused light is non-parallel light. In particular a diffusion center appears to an observer at different observation angles in the color of the incident light. In particular the storage unit is translucent in the region of the diffusion center. The diffusion center can advantageously be configured as sub-surface engraving, particularly advantageously as sub-surface engraving of an at least partially transparent and/or partially translucent glass plate or an at least partially transparent and/or partially translucent plastic plate. This advantageously allows defined regions of the storage unit to be lit in a specific manner. In particular it allows storage units to be lit in a simple manner. It advantageously allows at least one edge of the storage unit to be lit. It also particularly advantageously allows at least one edge of a frameless shelf, in particular of a transparent and/or translucent shelf, to be lit. In particular it allows engraving on the storage unit to be lit, advantageously a sub-surface engraving, particularly advantageously an engraved logo. This advantageously allows a graphic to be illuminated in the glass.

The invention is also based on a method with a domestic appliance device, in particular a domestic refrigeration appliance device, with at least one storage unit, which is held in at least one operating state, in which the storage unit is present in its entirety in the appliance carcass.

It is proposed that the storage unit is held as a maximum in an edge region of the storage unit, its extension in at least one direction perpendicular to a direction of a torque resulting during holding corresponding to maximum 30%, in particular maximum 20%, preferably maximum 15%, advantageously maximum 10% and particularly advantageously maximum 6% of the extension of the storage unit along this direction. The inventive configuration allows in particular advantageous support for storage units of a domestic appliance device, in particular a domestic refrigeration appliance device. In particular storage units can be arranged in a domestic appliance carcass with predominantly flat walls, which in particular makes the walls easy to clean. The storage units are also advantageously easy to clean, in particular at edges away from the edge region. Differently configured storage units, in particular shelves or bottle storage units, can advantageously be held just at one side in a domestic appliance. This gives the inner chamber in particular a homogeneous appearance. Storage units made of different materials can also advantageously be held in a similar manner.

The domestic appliance device here should not be limited to the application and embodiment described above. In particular the domestic appliance device can have a number of individual elements, components and units that is different from a number cited herein in order to implement a mode of operation described herein.

Further advantages will emerge from the description of the drawings which follows. The drawing shows exemplary embodiments of the invention. The drawing, description and claims contain numerous features in combination. The person skilled in the art will expediently also consider the features individually and combine them in useful further combinations.

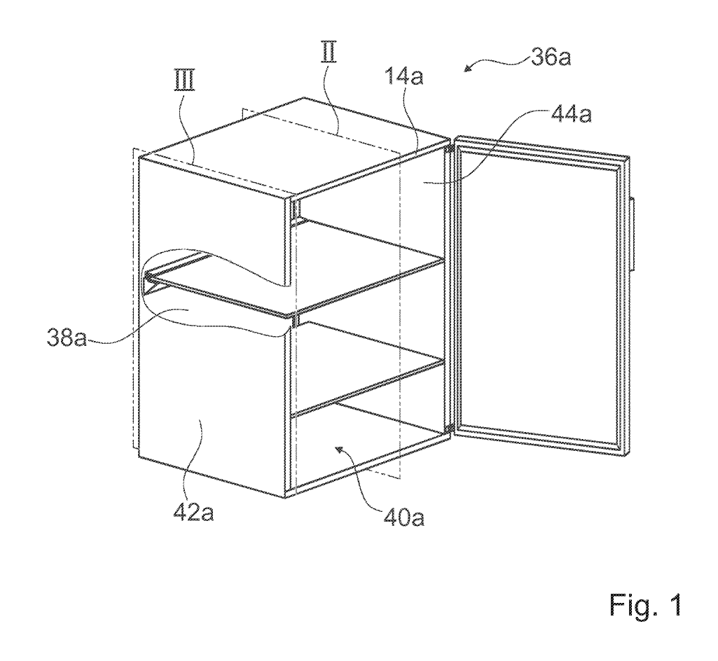

FIG. 1 shows a schematic front view of a domestic refrigeration appliance with a domestic appliance device,

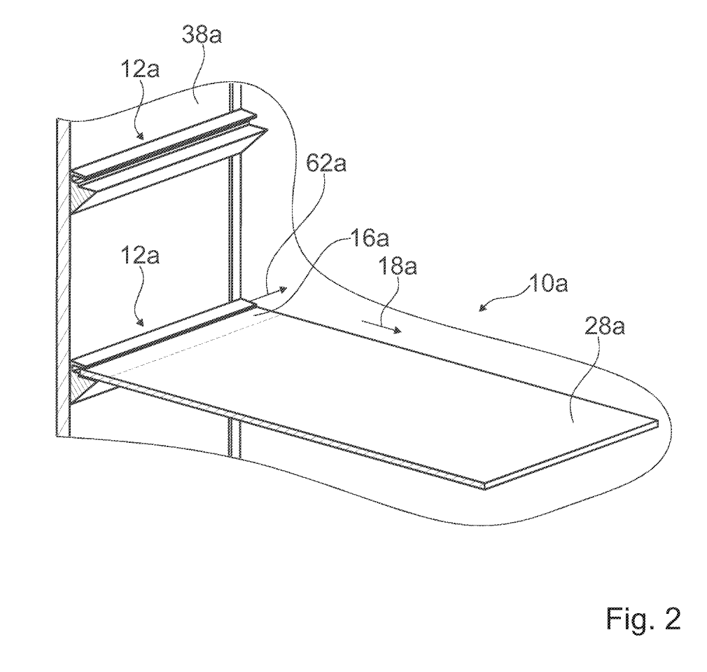

FIG. 2 shows a perspective sectional view along a plane II in FIG. 1 of a domestic appliance device with a storage unit and a holding unit, which holds the storage unit along one side in an edge region,

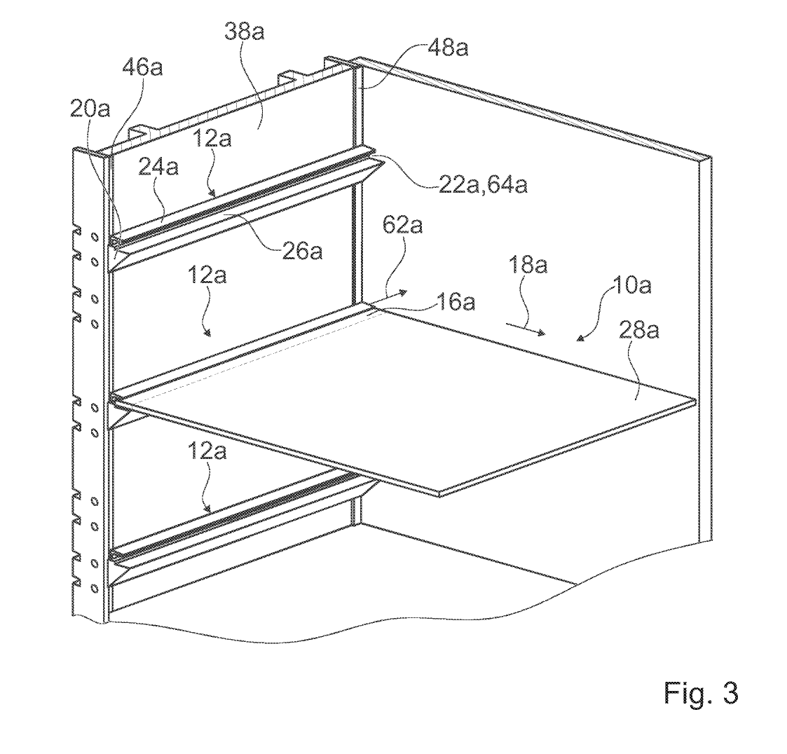

FIG. 3 shows a perspective sectional view along a plane III in FIG. 1 of the domestic appliance device,

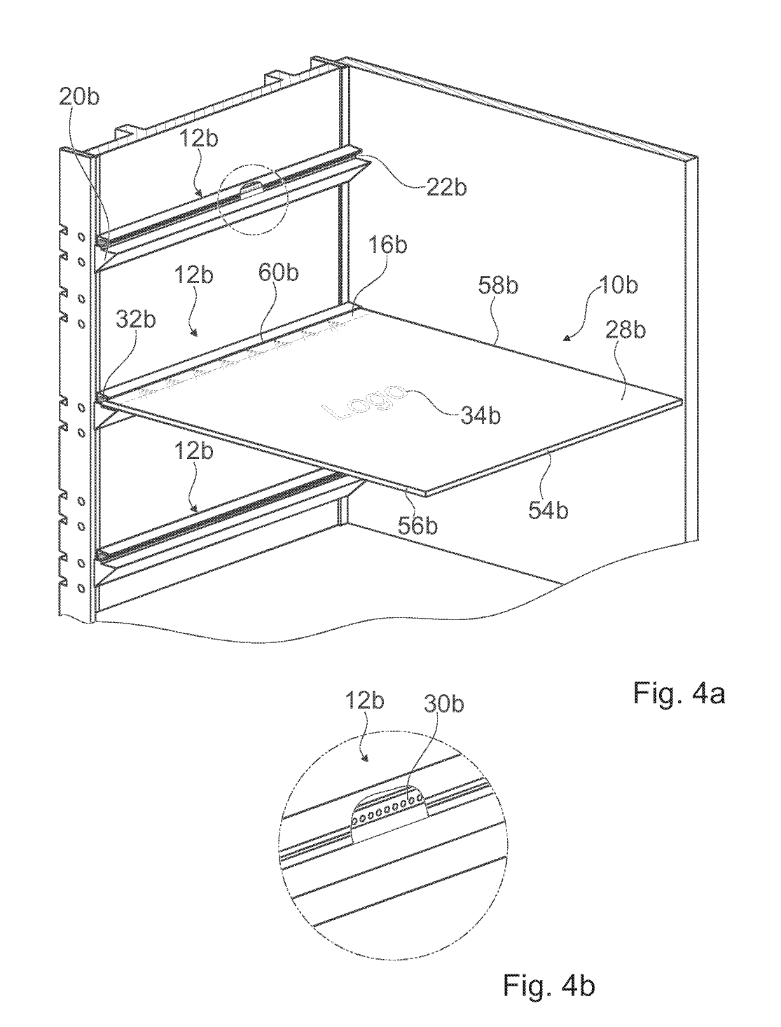

FIG. 4 shows a perspective sectional view along a plane III in FIG. 1 of a further domestic appliance device with a holding unit with a light source and with a storage unit with an engraved logo,

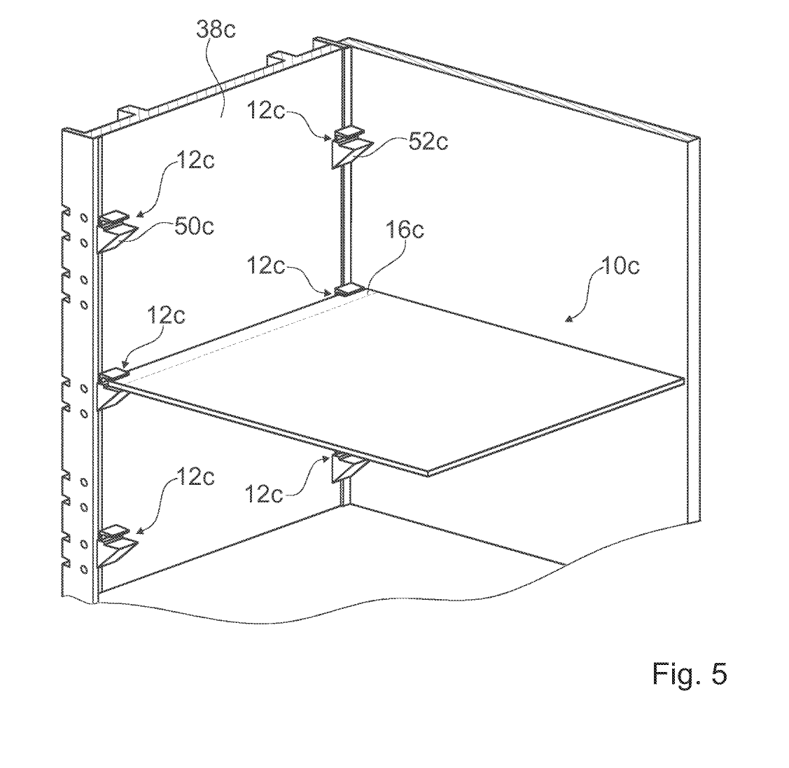

FIG. 5 shows a perspective sectional view along a plane III in FIG. 1 of a further domestic appliance device with a further alternative holding unit.

FIG. 1 shows a schematic front view of a domestic appliance 36a configured as a domestic refrigeration appliance. The domestic appliance is configured as a refrigerator. The domestic appliance 36a comprises a domestic appliance device. In the present instance the domestic appliance device is provided to store food and chilled goods in a chilled manner. The domestic appliance device has an appliance carcass 14a with side walls 42a, 44a and a rear wall 38a, which defines an inner chamber 40a.

FIG. 2 shows a perspective sectional view along a plane II in FIG. 1. The domestic appliance device has a storage unit 10a and a holding unit 12a, which in an assembled state holds the storage unit 10a in an edge region 16a. In the present instance the holding unit 12a is arranged on a rear wall 38a of the appliance carcass 14a in the inner chamber 40a. In the assembled state the storage unit 10a is present in its entirety in the inner chamber 40a. In the present instance the storage unit 10a has a shelf 28a. When the storage unit 10a is held, a torque 62a results, which acts at least substantially parallel to a main extension direction of the holding unit 12a. The edge region 16a extends in at least one direction 18a perpendicular to the torque over maximum 30% of the length of the storage unit 10a in said direction 18a. In the present instance the direction 18a runs parallel to a side edge of the shelf 28a. Also in the present instance the extension of the edge region 16a in the direction 18a is around 6% of the extension of the storage unit 10a in said direction 18a.

FIG. 3 shows a perspective sectional view along a plane III in FIG. 1. In the present instance the holding unit 12a is fastened to two vertical rails 46a, 48a of the domestic appliance device, which can at least partially absorb the force of gravity of the storage unit 10a and/or the torque 62a resulting in the edge region 16a during holding. In the present instance the rails 46a, 48a are connected to the rear wall 38a of the appliance carcass 14a. The height of the holding unit 12a can be adjusted along the rails 46a, 48a.

The holding unit 12a has a holding profile 20a with a holding recess 22a, into which at least part of the edge region 16a can be inserted. In the present instance the holding profile 20a has an at least substantially constant cross section along its main extension direction. The holding profile 20a also extends over at least a majority of the length of the holding unit 12a. The holding recess 22a has an upper holding element 24a and a lower holding element 26a, which at least partially delimit the holding recess 22a. The lower holding element 26a has a greater extension along the direction 18a than the upper holding element 24a. The holding recess 22a here extends at least substantially in a horizontal direction, parallel to a substrate (not shown), on which the domestic appliance 36a is positioned. The holding recess 22a also runs at least substantially parallel to a main extension direction of the holding unit. In the present instance the holding elements 24a, 26a are configured as walls, which define a groove 64a. In at least one region the groove 64a follows the shape of the edge region 16a so that in an inserted state the storage unit 10a is connected to the holding unit 12a with a form fit. The storage unit 10a here rests on the lower holding element 26a, which is longer in the direction 18a, and is braced from above by the upper holding element 24a, which is shorter in the direction 18a.

The shelf 28a can be at least at least partially transparent and frameless and/or translucent and frameless. In the present instance the shelf 28a is configured as a frameless glass plate. The shelf 28a can however also be configured for example as a frameless shelf made of a suitable clear plastic (not shown).

FIG. 4 shows a further exemplary embodiment of the invention. The following descriptions are limited substantially to the differences between the exemplary embodiments, it being possible to refer to the description of the exemplary embodiment in FIGS. 1 to 3 for identical components, features and functions. To distinguish between the exemplary embodiments the letter a in the reference characters of the exemplary embodiment in FIGS. 1 to 3 is replaced by the letter b in the reference characters of the exemplary embodiment in FIG. 4. It is possible in principle also to refer to the drawings and/or the description of the exemplary embodiment in FIGS. 1 to 3 for identically referenced components, in particular for components with identical reference characters.

FIG. 4 shows a vertical section through the domestic appliance 36b with a domestic appliance device. A holding unit 12b has a light source 30b. The light source 30b is provided to couple light into a storage unit 10b with a shelf 28b at at least one point 32b on an edge region 16b. In the present instance the light source 30b has an LED strip, which is arranged in a holding recess 22b and runs along the main extension direction of a holding profile 20b. When the light source 30b is operating, light is coupled into the storage unit 10b through a rear edge 60b of the storage unit 10b. In the present instance light is coupled in through the edge of the shelf 28b and diffused in the shelf 28b at least substantially in a horizontal direction, as coupled in light is reflected back off the sides of the shelf 28b primarily into the shelf 28b in the manner of a light guide due to the material of the shelf 28b having a higher refractive index than the refractive index of its surroundings, in particular air. The light source 30b can be activated or deactivated by a user and/or the holding unit 12b can have a sensor (not shown), which can recognize whether the storage unit 10b is inserted into the holding unit 12b, so the corresponding light source 30b is activated or deactivated automatically according to what has been recognized. The light source 30b is also deactivated when a door (not shown) of the domestic appliance 36b is closed and switched to an activatable state when the door is opened.

The storage unit 10b has at least one diffusion center 34b. The diffusion center 34b is provided to couple out at least some of the light coupled into the storage unit 10b, in particular visible light, ultraviolet light and/or light from the near infrared. The structure of the material of the storage unit 10b in the region of the diffusion center 34b causes light guided through the storage unit 10b to be coupled out preferably in the region of the diffusion center 34b, in other words to be diffused out of the storage unit 10b into the surroundings. In the present instance the shelf 28b has a first diffusion center 34b, which is configured as a sub-surface engraving on the shelf 28b in the form of a company logo, being lit by the coupled out light. Also in the present instance a front edge 54b and side edges 56b, 58b are further diffusion centers so that light coupled in at the point on the edge region 32b is also coupled out at said edges 54b, 56b, 58b, lighting up the edges 54b, 56b, 58b.

FIG. 5 shows a further exemplary embodiment of the invention. The following descriptions are limited substantially to the differences between the exemplary embodiments, it being possible to refer to the description of the exemplary embodiments in FIGS. 1 to 4 for identical components, features and functions. To distinguish between the exemplary embodiments the letter a or b in the reference characters of the exemplary embodiments in FIGS. 1 to 4 is replaced by the letter c in the reference characters of the exemplary embodiment in FIG. 5. It is possible in principle also to refer to the drawings and/or the description of the exemplary embodiments in FIGS. 1 to 4 for identically referenced components, in particular for components with identical reference characters.

FIG. 5 shows a perspective sectional view along a plane III in FIG. 1 of a further domestic appliance 36c with a domestic appliance device. A holding unit 12c has a first holding part 50c and a second holding part 52c. In the present instance the holding part 50c and the holding part 52c have at least substantially identical cross sections and hold a storage unit 10c at opposing sides of an edge region 16c. The holding parts 50c, 52c here are fastened in such a manner that their height can be adjusted with rails 46c, 48c arranged on a rear wall 38c of an appliance carcass 14c. Alternatively it would also be possible for a holding unit to have two holding parts, which are arranged on opposing side walls of an appliance carcass and hold the storage unit in an edge region as in above edge regions (not shown).

### REFERENCE CHARACTERS

10 Storage unit
12 Holding unit
14 Appliance carcass
16 Edge region
18 Direction
20 Holding profile
22 Holding recess
24 Holding element
26 Holding element
28 Shelf
30 Light source
32 Point on edge region
34 Diffusion center
36 Domestic appliance
38 Rear wall
40 Inner chamber
42 Side wall
44 Side wall
46 Rail
48 Rail
50 Holding part
52 Holding part
54 Edge
56 Edge
58 Edge
60 Edge
62 Torque
64 Groove

1-15. (canceled)

16. A domestic appliance device or domestic refrigeration appliance device, comprising:
an appliance body;
at least one storage unit having an extension and having an edge region with an extension;
at least one holding unit holding said at least one storage unit at most in said edge region and entirety within said appliance body in at least one operating state;
said holding of said at least one storage unit by said at least one holding unit resulting in a torque defining a direction of said torque; and
said extension of said edge region corresponding in at least one direction perpendicular to said direction of said torque to at most 30% of said extension of said at least one storage unit along said at least one direction perpendicular to said direction of said torque.

17. The domestic appliance device according to claim 16, wherein said at least one holding unit is disposed in said appliance body.

18. The domestic appliance device according to claim 17, wherein said appliance body has a rear region, and said at least one holding unit is disposed in said rear region.

19. The domestic appliance device according to claim 16, wherein said at least one holding unit has at least one holding profile with at least one holding recess, and at least part of said edge region is insertable into said at least one holding recess.

20. The domestic appliance device according to claim 19, wherein said at least one holding profile has at least one upper holding element and at least one lower holding element at least partially delimiting said holding recess, and said at least one lower holding element has a greater extension along said at least one direction perpendicular to said direction of said torque than said at least one upper holding element.

21. The domestic appliance device according to claim 19, wherein said at least one holding recess has a main extension direction running at least substantially in a horizontal direction.

22. The domestic appliance device according to claim 19, wherein said at least one holding unit has a main extension direction, and said at least one holding recess has a main extension direction running at least substantially parallel to said main extension direction of said at least one holding unit.

23. The domestic appliance device according to claim 19, wherein said at least one holding unit has an extension with a main extension direction, and said at least one holding profile extends over at least a majority of said extension of said at least one holding unit.

24. The domestic appliance device according to claim 16, wherein said at least one storage unit has a shelf.

25. The domestic appliance device according to claim 24, wherein said shelf is at least one of at least partially transparent and frameless or at least partially translucent and frameless.

26. The domestic appliance device according to claim 16, wherein said at least one holding unit has at least one light source for coupling light into said storage unit at least at one point on said edge region.

27. The domestic appliance device according to claim 26, wherein said storage unit has at least one diffusion center for coupling out at least some of the light coupled into said storage unit.

28. A domestic appliance or domestic refrigeration appliance, comprising a domestic appliance device according to claim 16.

29. A holding unit for the domestic appliance device according to claim 16.

30. A method for assembling a domestic appliance device or a domestic refrigeration appliance device, the method comprising the following steps:
providing at least one storage unit having an extension and an edge region;
placing the at least one storage unit entirely within an appliance body;
holding at most the edge region of the at least one storage unit in at least one operating state resulting in a torque having a direction; and
providing the edge region with an extension corresponding in at least one direction perpendicular to the direction of the torque to at most 30% of the extension of the at least one storage unit along the direction perpendicular to the direction of the torque.

31. The method according to claim 30, which further comprises using at least one holding unit to hold the at least one storage unit.
